(19) United States
(12) Patent Application Publication
(10) Pub. No.: US 2017/0372437 A1
(43) Pub. Date: Dec. 28, 2017

(54) METHOD OF DETERMINING PROBABILISTIC OPERABILITY REQUIREMENTS FOR A SYSTEM AND ITS COMPONENT SUBSYSTEMS

(71) Applicant: SNECMA, Paris (FR)

(72) Inventors: Guillaume GALATEAU, Mont Saint Algnan (FR); Sebastien REICHSTADT, Asnieres Sur Seine (FR); Tristan LE FEVRE, Houlbec Cocherel (FR); Philippe JAMES, Vernon (FR)

(73) Assignee: SNECMA, Paris (FR)

(21) Appl. No.: 15/542,229

(22) PCT Filed: Jan. 8, 2016
(86) PCT No.: PCT/FR2016/050036

§ 371 Date: Jul. 7, 2017

(30) Foreign Application Priority Data
Jan. 9, 2015 (FR) 1550178
Jan. 9, 2015 (FR) 1550179

(51) Int. Cl. G06Q 50/04; F02K 9/96; G06Q 10/06; G06Q 10/04

(52) U.S. Cl. CPC G06Q 50/04; G06Q 10/0635; F02K 9/96; G06Q 10/04

(57) ABSTRACT

A method of operation of a complex system includes obtaining a population of operating points in a multidimensional space having axes, each representative of a parameter of a subsystem of the system that is represented for characterization purposes; followed by constructing a plurality of limit domains in that space, each constructed around a reference point to encompass a proportion of the population defined in the subsystem plane under consideration, which plane corresponds to a projection of the operating points obtained at system level into the plane of the subsystem under consideration; followed, for each subsystem, by defining qualifying domains by counting points of the population lying outside a given limit; and as functions of the result of the counting and a target proportion for the population defined for the system, adapting the domain to define modified domains characterizing operation of the subsystems approaching a defined target for the system.

### TECHNICAL CONTEXT

The invention lies in the field of methods for characterizing industrial systems. The invention is applied to systems constituted by a plurality of subsystems, also referred to herein as “complex” systems. The invention relates more particularly to systems that need to be modeled in order to be characterized, as a result of a lack of feedback from significant hardware experiments. This might be due to the very large cost of hardware experiments, or to not enough time to obtain feedback from such experiments. Because of these constraints, the characterization needs to be predictive.

The invention thus relates to a method of determining probabilistic operability requirements for a system and its component subsystems.

Rocket engines, or more generally thruster systems for the space industry, constitute an example of such complex systems that needs to be modeled in order to be characterized in predictive manner.

They are constituted by various subsystems that are fabricated by distinct manufacturers, on the basis of specifications issued by a principal carrying out or having carried out assembly of the system. By way of example, such subsystems may be an oxygen turbopump, a hydrogen turbopump, a gas generator, valves, or the propulsion chamber of the engine, assuming that it is a liquid propellant rocket engine.

Contractual relationships relating to the behavior of the subsystems and of the system under conditions of operation are defined between the players involved with development and with fabrication, and in particular probabilities are defined for required success rates of flights.

In the context of contractual relationships, each subsystem is defined precisely, but within the limits of uncertainties that are inherent to the production process. Specifically, it is expected that each copy of a subsystem that is produced will be slightly different from the others. Although such variability is constrained by demanding production processes, it is submitted herein that it is still necessary to take it into account in order to model accurately the behavior of the subsystems and the behavior of the system.

In the same manner, uncertainties exist about interface conditions between two subsystems within the system once it has been assembled, or about environmental conditions (e.g. operating on a test bench or under real launch conditions). These uncertainties are also strictly constrained, but it is submitted herein that it is desirable to incorporate them in a model simulating the operation of the system.

Uncertainties can also appear in the process of setting up subsystems and the system. It is also submitted that it is desirable to incorporate these uncertainties in the model of the system.

Likewise, uncertainties arise early on in the development program, since the final product is still poorly understood for reasons associated with lack of maturity, and with lack of testing of the system, at the time the subsystems and the system under development are being characterized. As a result, the models used for establishing operating domains lack representivity and accuracy. It is nevertheless desirable to be in a position to characterize the complex system early on in the development program over the entire operating range expected during the qualification stage (qualification domains), in preparation for the production stage (operating domains in operational mode, e.g. the flight operating domain for a rocket engine).

Finally, during the operational lifetime of a system and of its subsystems, certain parameters may drift, giving rise to additional uncertainty. It is also submitted herein that this uncertainty needs to be incorporated in a model.

A method previously implemented makes use of uncertainties being represented by independent Gaussian statistical distributions.

In that prior method, an engine model is also used that is simplified by being linearized in the vicinity of a specified mean operating point. The operating point is defined by numerical values for various operating parameters, each relating either to the complete system, or to a subsystem. These parameters include performance (in particular the performance of parameters of each of the subsystems) and interface conditions, characterizing feed variabilities in the system.

Defining such performance parameters or interface conditions associated with the subsystems makes it possible to visualize them in pairs in planes by means of axes representing two different performance parameters of the system or of a subsystem, or two different interface conditions, which planes relate both to the system (generally one or two planes relating to the complex system, but sometimes more) and also to the subsystems.

In that previously implemented method, the use of Gaussian distributions for modeling the uncertainties leads to operating domains being represented in such planes for the purpose of covering that proportion of the real situations encountered by a system in operation which satisfy a target success rate. The domains in question are represented by ellipses.

Those ellipses are each centered on a point that is defined in each plane by an average engine, by a particular (target) setting of the engine, and by particular flight conditions, relating essentially to one stage of flight.

In that approach, the size and the eccentricity of the ellipses in each plane (as given by the dimensions of the two axes) are defined by a single probability rate that is applied without distinction both to the planes relating to the complex system and also to the planes relating to the subsystems. The orientation of the ellipse and its eccentricity are defined by a sensitivity matrix enabling the system plane to be projected onto the subsystem planes. Furthermore, in order to save on computation, the size is sometimes considered, as a simplifying assumption, to be identical (invariant at the operating point) regardless of the point under consideration, but without any functional or behavioral justification.

Unfortunately, proceeding in that way leads to assuming that every copy of the system that does not lie within the operating domain defined for the system (and therefore does not satisfy the specification) has all of its subsystems simultaneously lying outside their respective operating domains.

Since the probability rate used is defined for the system as a whole, it constitutes a line of reasoning that leads to neglecting situations in which one or more subsystems lie outside their operating domains, while one or more other subsystems are indeed within their operating domains.

However, the subsystems are designed and dimensioned on the basis of the operating domains defined for the subsystems during the development stage. Thus, the operating domains of the subsystems must not be defined too narrowly.

In order to mitigate that difficulty in particular, an alternative solution has been sought.

It is based on the availability of computation means of increased power as a result of progress with computers and techniques for parallel computation using clusters, making it possible to proceed with simulations of configurations and behaviors in operation for numerous copies of complex systems, thus making it possible to have a statistically significant quantity of data, equivalent to data feedback from experiments for more conventional systems. By way of example, such calculation means make use of Monte Carlo simulations in order to generate a population. The uncertainties may be modeled by distributions that are not necessarily Gaussian, and it is possible to take account of correlations between parameters.

Regardless of whether the population of operating points is obtained in this way or in some other way, the above-mentioned problem that the presently-described method seeks to overcome is the difficulty of properly defining subsystem domains for the target reliability of the system they make up, knowing that these domains drive and constrain the dimensioning of the subsystems.

### Definition of the Invention and Associated Advantages

To solve this problem, a method is proposed herein for determining probabilistic operability requirements for a system, and its component subsystems, the method being characterized in that it comprises:
an obtaining step for obtaining a population of operating points of the system including said component subsystems, with dispersed operating conditions in a multidimensional space having axes that are each representative either of a parameter of a subsystem of the system that is represented for characterization purposes, or else of an interface of the subsystem;
followed by a construction step for constructing a plurality of predefined limit domains of said space, each representing a different subsystem, each limit domain being constructed as encompassing, around a reference point, a proportion of said population defined in the plane of the subsystem under consideration, corresponding to a projection of the operating points obtained at system level onto the plane of the subsystem under consideration, these limit domains representing observable operating conditions of the system when in operation, resulting from various sources of dispersion;
followed, for each subsystem, by a definition step for defining qualifying domains by counting points of the population lying outside a given limit; and
a step in which, as a function of the result of counting for each subsystem and of a proportional target for said population defined for the system, applying an adaptation to the domains of the subsystems in order to define modified domains characterizing subsystem operation approaching an overall reliability target defined for the system (so as to ensure consistency, which consists in converting an overall reliability target for the system into a reliability target for each subsystem).

Relative to the limit domains, the qualifying domains introduced qualifying directions in which the main modes of failure are critical (e.g. such as robustness in the face of pressure loading or fatigue due to thermal loading), and functional limitations for the subsystems constituted by criteria that must not be exceeded during a stage of development or of production under pain of harming the functional or mechanical integrity of the subsystem in question, or of the system itself, these criteria serving to quantify margins for the subsystems relative to their modes of failure.

The quantitative criteria that are associated with the qualifying directions are defined with margins that are larger during the development stage than under observable conditions during real operation.

The invention also provides a design method for designing a rocket engine or a space vehicle propulsion system, and its component subsystems, the method comprising:

a) a determination stage for determining probabilistic operability requirements for said engine or for said system for nominal operating conditions in flight, this determination stage comprising:
an obtaining step for obtaining a population of operating points of the rocket engine or of the space vehicle propulsion system including at least two subsystems selected from an oxygen turbopump (TPO), a hydrogen turbopump (TPH), a gas generator, valves (VPH, VPO, VCO, VCH, VBPH, VBPO), and a propulsion chamber (CP) of the rocket engine;
followed by a construction step for constructing a plurality of predefined limit domains of said space, each representing a different subsystem, each limit domain being constructed as encompassing, around a reference point, a proportion of said population defined in the plane of the subsystem under consideration, corresponding to a projection of the operating points obtained at system level onto the plane of the subsystem under consideration, these limit domains representing observable operating conditions of the rocket engine or of the space vehicle propulsion system when in operation, resulting from various sources of dispersion;

b) a determination stage for determining probabilistic operability requirements for said engine or said system in order to qualify them, followed, for each subsystem, by a definition step for defining qualifying domains by counting points of the population lying outside a given limit, wherein said qualifying domains introduce relative to the limit domains:
qualifying directions in which the main modes of failure are critical; and
functional limitations for the subsystems constituted by criteria that must not be exceeded during a stage of development or of production;
   under pain of harming the functional or mechanical integrity of the subsystem in question, or of the rocket engine, or of the space vehicle propulsion system itself, these criteria serving to quantify margins for the subsystems relative to their modes of failure;

c) an adaptation stage for adapting the domains of said subsystems as a function of the result of the counting for each subsystem and as a function of an overall reliability target defined for the rocket engine or for the space vehicle propulsion system, e.g. the proportion of said defined population for the rocket engine or for the space vehicle propulsion system;
the associated criteria defined for said subsystem that need to be complied with during a stage of development or a stage of producing said subsystems.

In an implementation, during said obtaining step, said population of operating points of the rocket engine or of the space vehicle propulsion system including at least two subsystems selected from an oxygen turbopump (TPO), a hydrogen turbopump (TPH), a gas generator, valves (VPH, VPO, VCO, VCH, VBPH, VBPO), and a population chamber (CP) of the rocket engine are obtained with operating conditions that are dispersed in a multidimensional space having axes that are each representative either of a parameter of a subsystem of the rocket engine or of the space vehicle propulsion system as represented by characterization purposes, or else of an interface of a subsystem.

In another implementation, during said obtaining step, said population of operating points of the rocket engine or of the space vehicle propulsion system including at least two subsystems selected from an oxygen turbopump (TPO), a hydrogen turbopump (TPH), a gas generator, valves (VPH, VPO, VCO, VCH, VBPH, VBPO), and a population chamber (CP) of the rocket engine is obtained, said population being constructed by effective anchoring, as made possible by this new method, of the predictive data associated with said systems and subsystems, on:
the real capability of producing various pieces of equipment and the way that capability varies, e.g. drifts in production, or improvements in fabrication processes resulting from taking appropriate account of fabrication dispersions, e.g. arbitrary statistical distributions anchored on series of equipment that have actually been fabricated;
the real capability of implementing and measuring/observing the operation of equipment on a test bench and the variations in that capability, e.g. in terms of feeding the engine, regulating testing by taking appropriate account of uncertainties in the conditions under which tests are performed; and
the predictive capability of the models used and the way that capability varies, e.g. as a reduction of misconceptions, acquiring experience during testing, enrichment of methods.

The characteristics below apply equally well to the characterization method and to the design method of the invention.

The margins of the subsystems relative to their modes of failure during the lifetime of the product during a development stage followed by a production stage are caused to vary either upwards in the event of a decrease in misconceptions, or downwards in the event of drifts in production.

The method employed serves in particular to share the qualification target for the various subsystems when the directions for qualifying them are in common.

Two families of domains are finally constructed for each subsystem, and also for the system that they make up:
operating limit domains, representing possible operating conditions for the system and/or the subsystem resulting from fabrication dispersions and/or operating dispersions that will be encountered in operation during the stage of producing a complex system such as an engine; and
qualifying domains, or extreme domains, that apply margins around the limit domains (taking account of random events in development, production drifts, potential for growth, etc., as can occur during development or during the stage of operating the complex system . . . ).

It is thus submitted herein that within the operating domains defined for the subsystems, certain directions that are considered to be qualifying ought to cover, with the provision of margins (random events, production drifts, . . . ), all operating conditions of the system in its operating domain, in order to ensure as high as possible a success rate in operation. Thus, the method proposed constitutes an improvement over prior techniques.

These margins serve to define qualifying criteria that ought to be reached during a qualification stage in order to demonstrate that the methods and procedures for fabricating and assembling the system and its subsystems are indeed suited to the expressed needs, and also that their behavior is consistent with expectations and that they are therefore indeed capable of covering the operating range that will be expected during a stage of production. This thus assumes that it is necessary to cover domains of parameters and of interface conditions of the system and of the subsystems that are greater than those actually expected during a stage of production. These criteria correspond to quantitative magnitudes for each parameter or interface condition of the subsystem under consideration in association with one or more modes of failure. These are computed on the basis of limit values for the subsystem parameters that might be reached during a stage of production, under real conditions of operation.

Finally, the described method sets out to define these margins as actually needed in order to cover:
uncertainties in systems for measuring the parameters or the interface conditions involved;
uncertainties associated with the predictive behavior model that is used, prior to qualification testing, to convert the subsystem qualification criteria involved into an engine operating point;
uncertainties associated with the control system making it possible to aim for the operating point under consideration of the system or of the subsystem; and
uncertainties associated with the behavior of the system and its subsystems that make it up. Since the parameters of the system and of its subsystems have been characterized during a first test referred to as a “reception” test, these uncertainties will then be limited to the fidelity of the system, i.e. its variability between repeated tests. In an implementation, reliability or the probability of proper operation is determined to define an operating domain, or in order to define a qualification domain. Under both circumstances, this probability of good operation or of reliability needs to be compatible with the functional limitations of the subsystems having values that have been defined by the authorities in charge of designing the subsystems in question. These values must not be exceeded during the stages of development, of qualification, or of production, and it is thus ensured that the proportion of the population that does not satisfy these criteria is smaller than the target reliability or probability of good operation.

For qualifying domains, account is also taken of the qualification criterion aspect. It is thus ensued that the proportion of the population for which the performance that is achieved is less than the qualifying criteria or greater than the functional limitations (associated with failure modes) or greater than the physical limitations (e.g. the range over which a valve can be adjusted), is less than the target probability for qualification success.

This proportion/reliability of said population for a subsystem is determined as a function of the number of degrees of freedom of the system and of the level of confidence required of the system.

The operating points of the system and of its component subsystems are obtained by simulation using a model of the complex system (including uncertainties) and by a statistical draw simulating the influence of various sources of dispersion, which might possibly be correlated, in order to define possible individuals of the population of systems.

These system simulations make it possible to build up a multidimensional database of system and subsystem parameters, that can be represented by a cloud of points of coordinates that are represented in two dimensions of the space under consideration constituting each operating plane or domain.

Since the system is multidimensional (the number of dimensions depending on the number of degrees of freedom), a domain is constructed by projecting points onto two dimensions in multidimensional space, the two dimensions both being representative of parameters or of conditions observed at the terminals of a given represented subsystem.

Several methods have been developed:
The “radar” method, which constitutes a preferred implementation, in which a domain is constructed while taking the coordinates of the operating points and of the reference points on at least two axes representing the respective subsystem into account, by using an arbitrary envelope obtained by overall counting (discretization and concatenation by angular sectors over the plane defined by the two axes).
In more general manner, under such circumstances, the domains are adapted by scaling to the limits of each of the domains of the subsystems in order to define modified domains characterizing an operation of the subsystems satisfying a reliability target defined at system level.
The generalized algebraic method, which is an alternative method presenting an intermediate degree of improvement over the previously-known original method, in which the construction of a domain in the multidimensional space comprises a step of normalizing the population as an equivalent Gaussian population, a step of constructing a domain on the basis of the normalized population, and an inverse transformation of the domain as constructed in this way in order to obtain the looked-for domain in the three-dimensional space.
Under such circumstances, in more general manner, the domains are adapted by iterative algebraic adaptation of the subsystems in order to define modified domains characterizing an operation of the subsystems approaching an overall reliability target defined for system.

The proportion of the population that is defined in the plane of the subsystem under consideration may be determined in operation so as to define a limit operating domain, or in qualification so as to define a qualifying operating domain.

A reliability specification for each subsystem can be determined on the basis of said population as a function of the number of degrees of freedom of the system and as a function of the rate imposed for the system.

The characterization method of the invention may in particular be applied to a complex system comprising a rocket engine or a space vehicle propulsion system.

In particular, the method of the invention may be applied to a complex system comprising a liquid propellant rocket engine having subsystems comprising at least two subsystems selected from an oxygen turbopump, a hydrogen turbopump, a gas generator, valves, and a rocket engine propulsion chamber.

The description of the invention is continued below with reference to the figures.

### LIST OF FIGURES

FIG. 1 is a diagram or a rocket engine, constituting an example of a complex system characterized by the invention.

FIG. 2 shows an implementation aspect of the invention (modular functional simulation of the rocket engine system).

FIG. 3 shows a population of operating points represented in a plane dedicated to a rocket engine.

FIGS. 4A to 4D show the same population of operating points in performance planes dedicated to the subsystems of the engine.

FIG. 5 shows a protocol for determining a (“limit”) operating domain in a plane dedicated to the engine.

FIG. 6 shows a protocol for determining (“qualifying” or “extreme”) dimensioning domains in planes that are dedicated to the subsystems of the engine, so as to identify subsystem performance that is critical concerning the failure modes of the subsystems.

FIG. 7 shows a protocol for determining operating domains in planes dedicated to the subsystems of the engine.

FIG. 8 shows an example of a (“limit”) flight operating domain in a plane dedicated to the engine.

FIG. 9 shows an example of a (“limit”) flight operating domain in a plane dedicated to a subsystem of the engine.

FIG. 10 shows an example of a qualification operating domain in a plane dedicated to a subsystem of the engine.

### DESCRIPTION OF AN IMPLEMENTATION

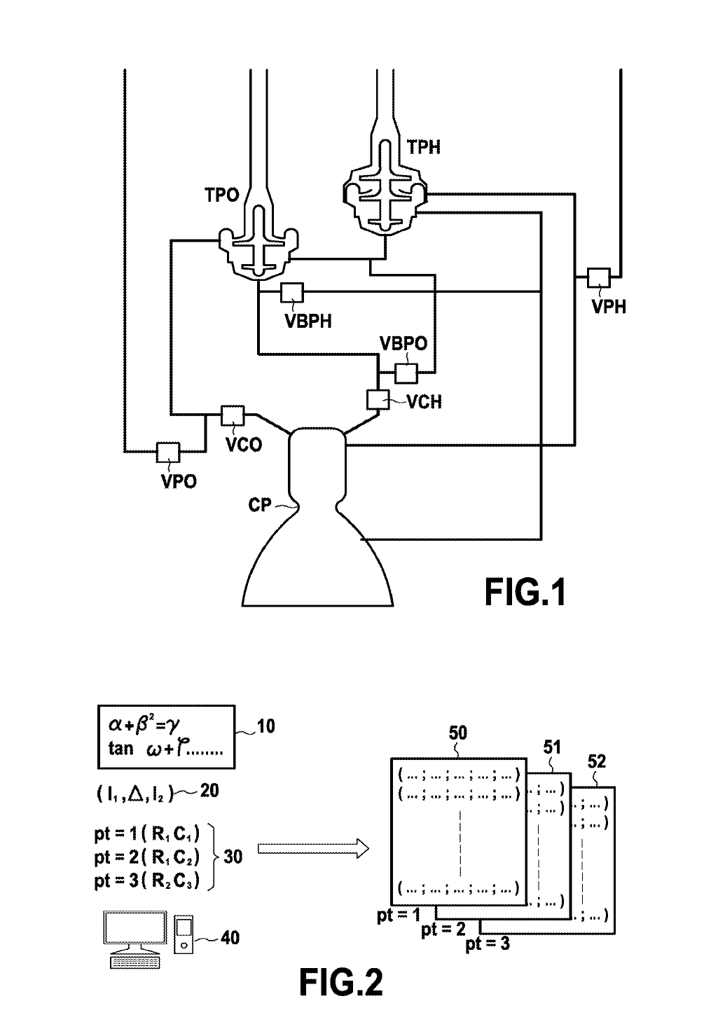

FIG. 1 shows a rocket engine in diagrammatic manner by way of illustration of an example of a complex system. It is made up of various subsystems, and in particular a propulsion chamber CP, a hydrogen turbopump TPH, an oxygen turbopump TPO, oxygen valves VPO and VCO, and hydrogen valves VPH, VCH, VBPH, and VBPO, however other subsystems could be included as a function of the operating cycle under consideration, such as a gas generator, for example. This is a liquid hydrogen engine using liquid hydrogen as fuel, however other systems can naturally be handled by a characterization method of the invention.

FIG. 2 shows the process in an implementation of the invention for obtaining a population of operating points for the FIG. 1 engine. A computer model 10 is written for the system, taking account of uncertainties 20 and of statistical distribution relationships associated with those uncertainties about various parameters, thus making it possible to simulate the operation of one particular copy of the engine under flight conditions, i.e. under real operating conditions. Powerful computation means 40 draw Monte Carlo samples to generate a large number of copies of the engine that are virtual but realistic, each copy being represented by numerical values for parameters that are specifically selected not only for their physical meaning relative to the phenomena that take place in a subsystem, but also for their ability to quantify the performance and the interface conditions of the subsystem when integrated in the engine, and also for their ability to take account of the impacts of manufacturing dispersion.

The experience of designers makes it possible to put limits on the realistic numerical values by means of distribution relationships, or indeed to correlate parameters with one another. The model generates the copies and enables flight operating points 50 to be computed. Each of these operating points comprises a plurality of parameters, also referred to as “performance parameters”. In general and in non-limiting manner, at least two parameters characterize the engine, where the number of parameters depends on the number of degrees of freedom of the system, while various parameters characterize the subsystems. For each subsystem, at least two parameters are generally selected.

The process is repeated with different settings for the engine, and for different flight conditions, corresponding in particular to different stages of flight (takeoff etc. . . . ), constituting a list 30 of setting and flight condition pairs. This leads to a plurality of banks 50, 51, 52, . . . of operating points that can be visualized and studied either together or else separately. Each bank corresponds to operating points simulated for a setting and a flight condition.

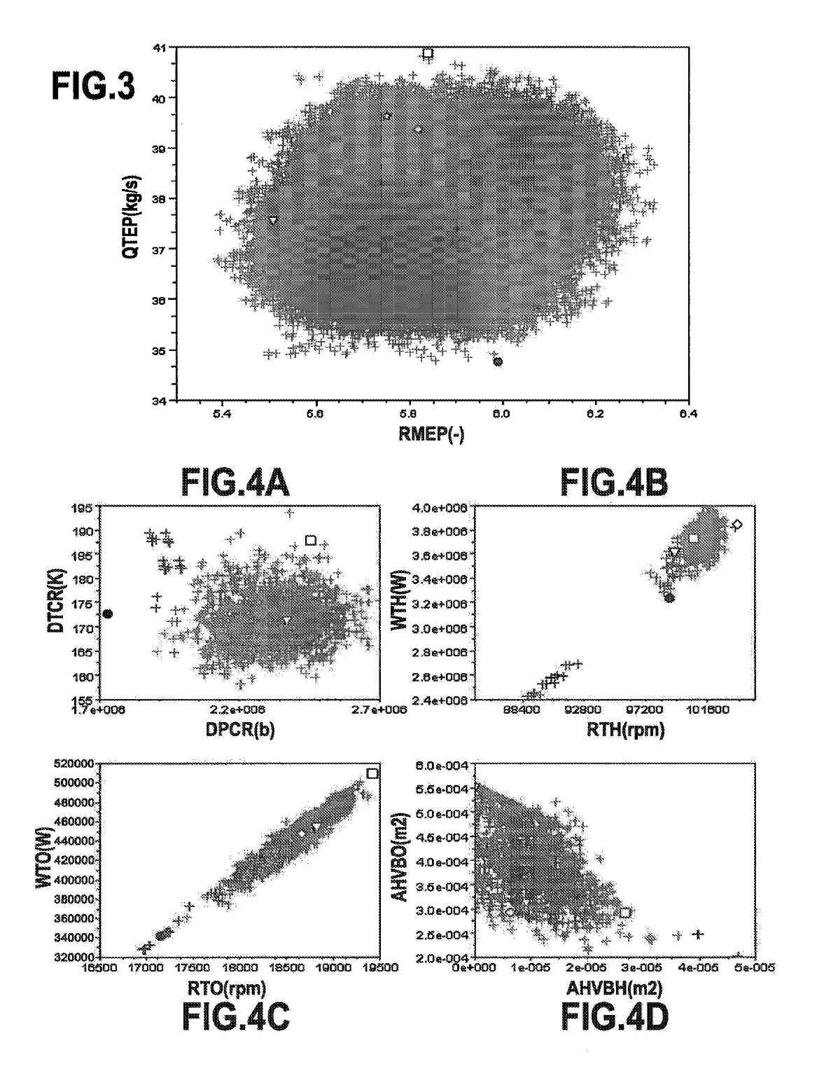

FIG. 3 shows a parameter plane of the engine, there being two parameters for the engine in question. Thus, the abscissa axis represents the mixing ratio (RMEP) of the species injected into the combustion chamber, and the ordinate axis represents the total thrust (QTEP) produced by the engine, and expressed in kilograms per second (kg/s). The operating points obtained by the Monte Carlo draw are represented in this plane, i.e. in this representation, parameters relating to the subsystems are ignored (in other words, the operating points are shown by being projected into the plane for parameters of the engine only).

It is specified that the operating points obtained for the various settings and flight stages are all shown in FIG. 3.

It can be seen that the points form a relatively compact mass, even though there are certain low-probability points that are relatively remote and that represent either conditions of the subsystems, or else systems that are far removed from the target.

In FIGS. 4A to 4D, there can be seen four parameter planes for subsystems. FIG. 4A concerns the regenerative circuit of the propulsion chamber CP, FIG. 4B represents the hydrogen turbopump TPH, FIG. 4C represents the oxygen turbopump TPO, and FIG. 4D represents an adjustment valve. Once again, in each plane, coordinates for points that do not relate to the parameters shown in that plane are ignored.

In FIG. 4A, the plane is defined by an abscissa axis representing a coefficient DPCR for the head loss of the regenerative circuit, and by an ordinate axis representing a coefficient DTCR for heating.

In FIG. 4B, the plane is defined by an abscissa axis representing the speed of rotation RTH in revolutions per minute of the hydrogen turbopump TPH, and by an ordinate axis representing the power in watts WTH of the hydrogen turbopump.

In FIG. 4C, the plane is defined by an abscissa axis representing the speed of rotation RTO in revolutions per minute for the oxygen turbopump TPO, and by an ordinate axis representing the power in watts WTO of the oxygen turbopump.

In FIG. 4D, the plane is defined by abscissa and ordinate axes representing hydraulic section limitations AHVBH and AHVBO expressed in square meters (m²) for the bypass valve under consideration.

It is specified that the operating points obtained for the various settings and flight stages are all shown in each of the planes.

It can be seen that the points always form compact masses, but of shapes that are very different from one another, and very different from the shape that can be seen in FIG. 3. Once more, there can also be seen a few isolated points that are characteristic of copies of a subsystem that depart very far from the target dimensioning, with probabilities of occurrence that are much less than the target reliability rate.

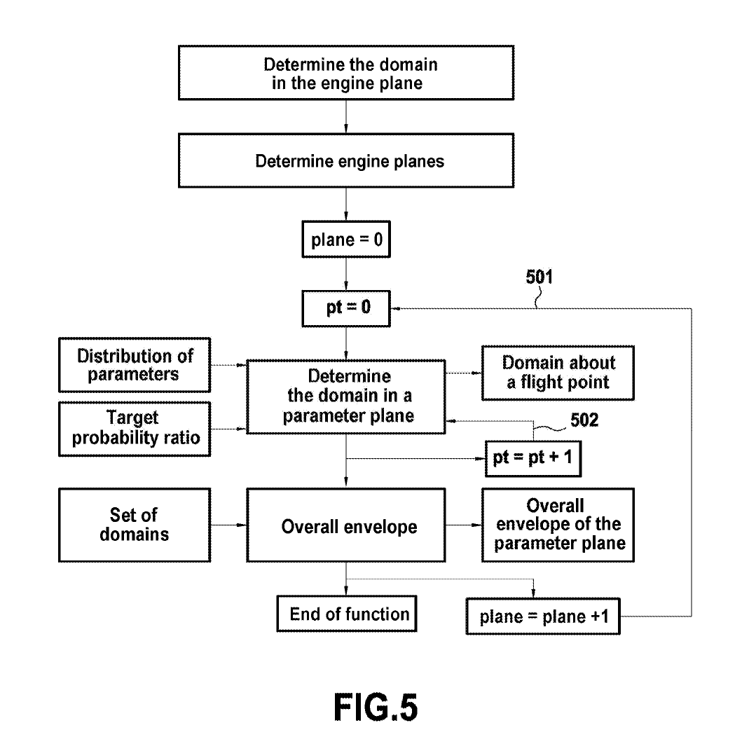

FIG. 5 shows a process of determining the operating domain in the parameter plane of the engine as shown in FIG. 3. If the system has more than two parameters for the engine, the process can be repeated for a plurality of parameter planes of the engine and it thus includes a loop 501 so as to be able to scan though all of the planes.

In a given plane, the banks of points obtained for a given setting and for a given flight condition (defining a flight point) are processed one after another. A loop 502 is thus used for scanning through the various flight points.

For a given flight operating point, the distribution of parameters (as contained in the bank of points) and the proportion P_{S} of points to be covered in the operating domain of the system (or the target probability rate) are used as input values to a function for determining the operating domain in the plane.

The function used for defining and constructing domains may be of various types. The invention is not limited to any one particular implementation.

It is possible to distinguish between:
a generalized counting method (referred to as the “radar” method); and
a generalized algebraic method based on using the Box-Cox method in order to convert to an equivalent Gaussian distribution (starting from any distribution), in which domains can be considered to be ellipses of eccentricity and size that are adjusted to approach the target reliability rate. An inverse Box-Cox transformation makes it possible to finish off by returning to the initial arbitrary distribution.

These two methods represent a change compared with the initial prior art method that is much more restrictive, being limited to Gaussian distributions only.

Under all circumstances, once the domains have been obtained for each flight point, an overall envelope is plotted for the domains, by any appropriate method, in order to merge the domains of the various flight points.

If necessary, i.e. if a Box-Cox transformation was used initially, the inverse transform is applied to the overall envelope.

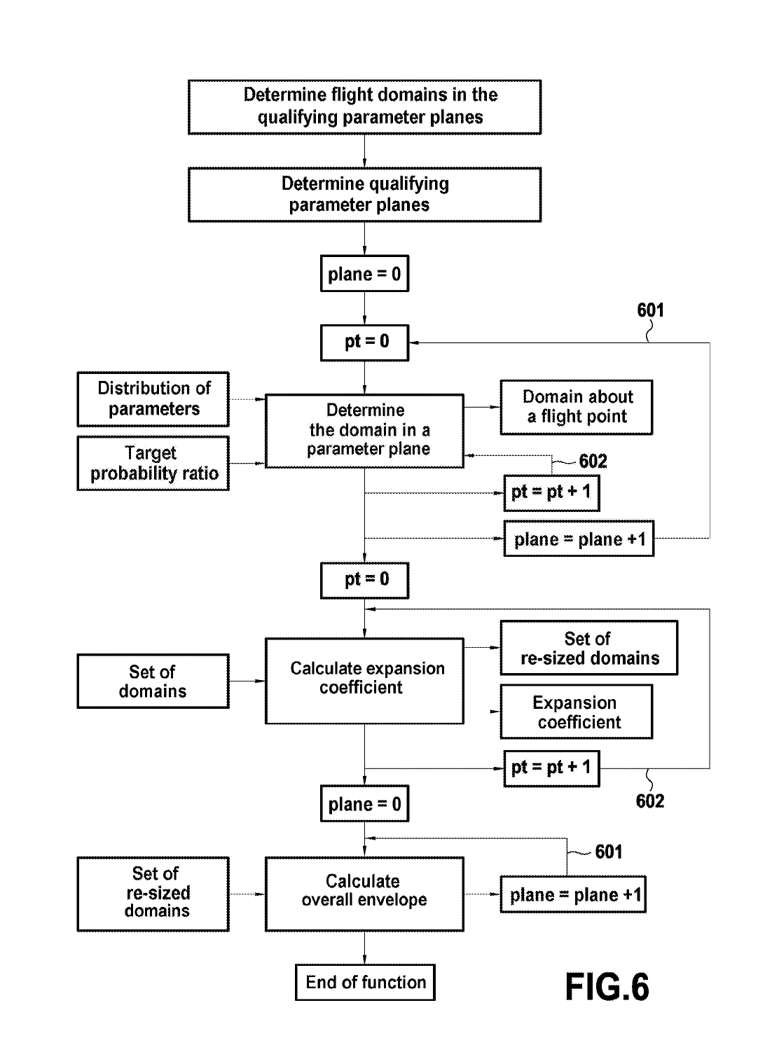

FIG. 6 shows a method of determining the operating domain in the parameter planes of subsystems that are considered to be qualifying for the system as a whole. In general, a plurality of planes are processed one after another, since a plurality of subsystems are concerned. It is also possible that a subsystem presents more than two parameters that are considered to be necessary for dimensioning purposes, requiring at least two planes to be processed for a single subsystem. It can also be necessary to couple them together in order to achieve the qualification criterion under consideration. A loop 601 is thus used in order to scan through all of the planes.

In a given plane, the banks of points that are obtained for a given setting and a given set of flight conditions (defining a flight point) are processed once more one after another. A loop 602 is thus used to scan through the various flight points.

For a given flight point, the distribution of parameters and the proportion of points to be included in the operating domain (or the target probability rate) are used as input values to a function for determining the operating domain in the plane. This function ignores the coordinates of points that do not relate to parameters concerned by the plane under consideration.

Once more, the function used may be of various different types (radar method, generalized algebraic method, . . . ). The invention is not limited to one particular implementation.

The generalized algebraic method is described in greater detail below.
For this generalized algebraic method, it is possible to use an ellipse of adjusted eccentricity and size serving to approach a target coverage rate for the parameter plane in question, possibly after applying the Box-Cox transformation to the distribution.
The target coverage rate P_{SS} for the parameter plane in question (in general a parameter plane relating to a subsystem) needs to be determined beforehand, and may be determined as follows:

P_{SS}=P_{S}/(nu−(nu₀−1))

where nu designates the number of degrees of freedom of the system determined on the basis of principal component analysis of the data bank 50, 51, or 52, . . . in question, and nu₀ is the degree of freedom of the parameter plane, i.e. nu₀=2.
The arithmetic means X′_{λ} and the standard deviation σ′_{λ} of each of the parameters of the plane are calculated, and then the correlation coefficient rx′₁x′₂ of the two parameters is calculated in turn (where the notation ′ represents computation performed in the Box-Cox plane).
The ellipse enveloping the parameters, at the coverage rate P_{SS} expressed in the form of a coefficient χ² for a population that is assumed to be Gaussian in a two-dimensional space centered on the flight point is then determined by taking account of these means, standard deviations, and correlation coefficient, in application of the equation:

$${( \frac{{x}_{λ}^{′} 1 - {X}_{λ}^{′} 1}{{σ}_{λ}^{′} 1} )}^{2} + {( \frac{{x}_{λ}^{′} 2 - {X}_{λ}^{′} 2}{{σ}_{λ}^{′} 2} )}^{2} - 2 {r}_{{x}^{′} 1 {x}^{′} 2} \cdot {( \frac{{x}_{λ}^{′} 1 - {X}_{λ}^{′} 1}{{σ}_{λ}^{′} 1} )}^{2} \cdot {( \frac{{x}_{λ}^{′} 2 - {X}_{λ}^{′} 2}{{σ}_{λ}^{′} 2} )}^{2} = ( 1 - {r}_{{x}^{′} 1 {x}^{′} 2}^{2} ) \cdot {χ}^{2} .$$

A specific function serves to optimize the ellipses by adapting the coefficient χ² and thus dimensioning the ellipses to the target reliability rate Ps for the system.

At the end of the process of determining envelopes in each plane for observing parameters of the subsystems, an iterative adaptation step is necessary to ensure that the domains are consistent with the requirement expressed overall as the reliability rate: the domains in the various subsystem planes are refined in order to ensure the overall reliability rate for the system. This step is essential to enable the main system manufacturer to determine in reasonable and constructive manner the levels of requirements in terms of reliability for all of the subsystems making up the complete system.

As mentioned above, the generalized algebraic method handles this point via an iterative algorithm for algebraically adapting the coefficient χ².

In the generalized method referred to as the “radar” method, an overall method of counting has been constructed seeking to define an expansion coefficient for each flight point. A loop is thus used to scan through all of the flight points. The method is as follows:
The expansion coefficient for a flight point can be calculated as soon as the operating domains for the flight point have been determined in all of the qualifying planes.
The expansion coefficient is computed by counting the points that lie outside at least one of the operating domains defined in one of the qualifying planes. Once this count has been undertaken, the remaining proportion of the points that lie in all of the domains is compared with the target probability rate for the engine as a whole.
The limits of each domain in each of the planes are then scaled, centered on the flight point and with an expansion coefficient that is determined so as to cause with the new limits, to approach the target probability rate for the engine as a whole.
The points that are not simultaneously within each of the qualifying domains are counted once more, and the expansion coefficient is adjusted, e.g. linearly on the basis of the difference of the observed missing point proportions. The operation is repeated as often as necessary in order to reach the target probability rate for the engine as a whole, within specified tolerance.

In summary, whether it is the method of optimizing ellipses (the generalized algebraic method), or the overall counting method (the “radar” method) that is used, it is the parameter P_{SS} (or the associated parameter χ²) that is adapted for each flight point, which parameter was initially identical for all of the flight points, in other words it is the reliability rate required for each subsystem that is adapted.

By adjusting the expansion coefficient for each flight point, (adjusted) modified domains are obtained in each plane and for each flight point.

Finally, the resulting domains are subjected in each plane to computing an overall envelope using any appropriate technique in order to merge the domains of the various flight points.

Once more, if a Box-Cox transformation was initially applied, the inverse transform is naturally applied to the overall envelope.

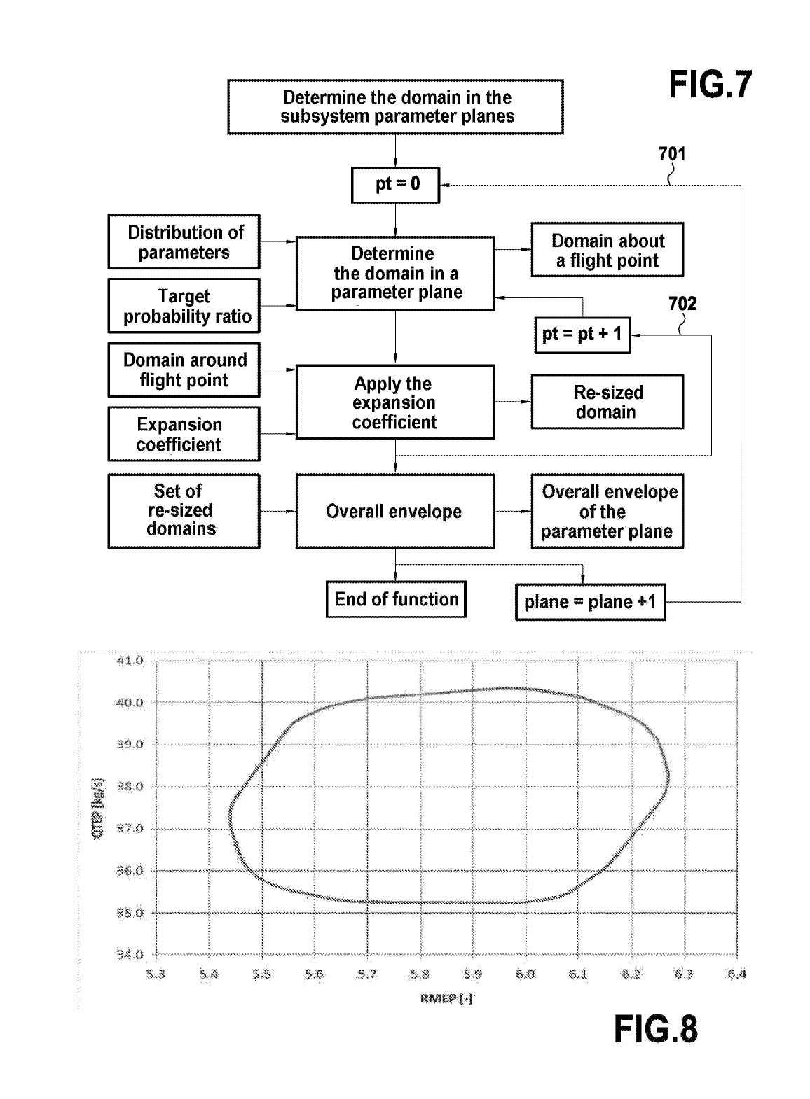

FIG. 7 shows a process of determining the operating domains in the parameter planes of the subsystems. Once more, a plurality of planes are processed one after another, since a plurality of subsystems are involved, and some subsystems may have more than two parameters that are needed for dimensioning. A loop 701 is thus used to scan through all of the planes.

In a given plane, the resulting point banks for a flight point are once more processed one after another. A loop 702 is thus used for scanning through the various flight points.

For a given flight point, the parameter distribution and the proportion of points to be included in the operating domain (or the target probability rate) are used as input values to a function for determining the operating domain in the plane. This function ignores the coordinates of points that do not relate to the parameters concerned by the plane under consideration.

Thereafter, the expansion coefficients for the respective flight points as calculated in FIG. 6 are applied to the domains in question. (Adjusted) modified domains are obtained in each plane and for each flight point.

Finally, in each plane, these domains are subjected to computing an overall envelope using any appropriate technique in order to merge the domains of the various flight points.

In the above-described process, it is possible to pass via the Box-Cox plane in order to determine the domains.

FIG. 8 shows the flight domain of a rocket engine determined by the principles as proposed above. The plane is the plane defined by an abscissa axis representing the mixing ratio (RMEP) (dimensionless) and the ordinate axis represents the total thrust (QTEP) expressed in kg/s. The probability rate used for the processes of FIG. 5 is the normal in-flight operating rate defined as being satisfactory in order to guarantee success of a program.

The domain shown is the overall envelope, computed so as to contain the domains obtained around flight points that correspond to various settings and flight conditions.

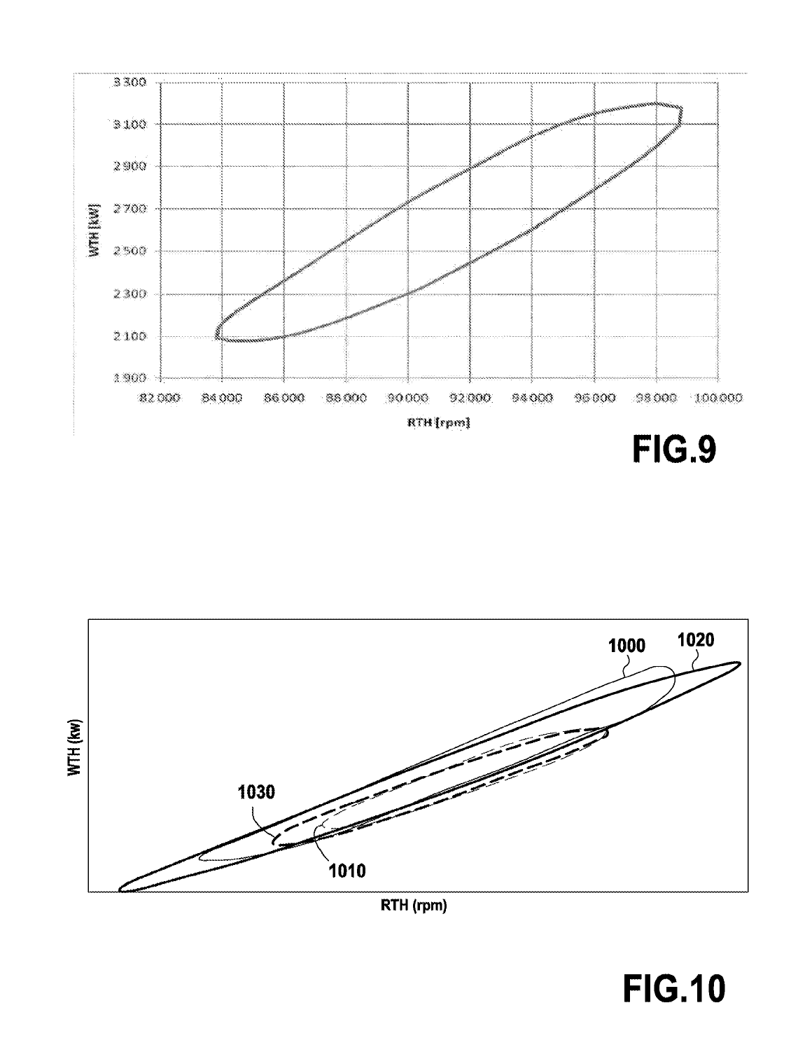

FIG. 9 shows the flight domain of a hydrogen turbopump of the FIG. 8 engine. The probability rate used is the probability rate mentioned with reference to FIG. 8. The domain shown is once more the overall envelope, computed so as to contain the domains obtained around flight points that correspond to various settings and flight conditions. The plane is defined by an abscissa axis representing the speed of rotation (RTPH) in revolutions per minute for the hydrogen turbopump, and by an ordinate axis representing the power (WTPH) in kilowatts for the hydrogen turbopump.

FIG. 10 shows the qualification domain 1000 of the hydrogen turbopump of the same engine. The probability rate used is the success rate (i.e. of achieving criteria) as required for qualification. The domain shown is once more the overall envelope, computed so as to contain the domains obtained around flight points corresponding to various adjustments and flight conditions. The figure also shows the flight domain 1010, which is logically included within the qualification domain 1000, and the qualification domain 1020 and the flight domain 1030 as obtained using the prior art method, it being submitted that although they are satisfactory, they are much less accurate.

The invention is not limited to the implementations described, but extends to all variants coming within the ambit of the scope of the claims.

1. A characterization method for determining probabilistic operability requirements for a rocket engine or a space vehicle propulsion system, and its component subsystems, the method comprising:
an obtaining step for obtaining a population of operating points of the rocket engine or of the space vehicle propulsion system including at least two subsystems selected from an oxygen turbopump, a hydrogen turbopump, a gas generator, valves, and a propulsion chamber of the rocket engine, with dispersed operating conditions in a multidimensional space having axes that are each representative either of a parameter of a subsystem of the rocket engine or of the space vehicle propulsion system that is represented for characterization purposes, or else of an interface of the subsystem;
followed by a construction step for constructing a plurality of predefined limit domains of said space, each representing a different subsystem, each limit domain being constructed as encompassing, around a reference point, a proportion of said population defined in the plane of the subsystem under consideration, corresponding to a projection of the operating points obtained at system level onto the plane of the subsystem under consideration, these limit domains representing observable operating conditions of the rocket engine or of the space vehicle propulsion system when in operation, resulting from various sources of dispersion;
followed, for each subsystem, by a definition step for defining qualifying domains by counting points of the population lying outside a given limit; and
a step in which, as a function of the result of counting for each subsystem and of a proportional target for said population defined for the rocket engine or for the space vehicle propulsion system, applying an adaptation to the domains of the subsystems in order to define modified domains characterizing subsystem operation approaching an overall reliability target defined for the rocket engine or for the space vehicle propulsion system.

2. The characterization method according to claim 1, wherein the qualifying domains introduce relative to the limit domains:
qualifying directions in which the main modes of failure are critical; and
functional limitations for the subsystems constituted by criteria that must not be exceeded during a stage of development or of production;
under pain of harming the functional or mechanical integrity of the subsystem in question, or of the rocket engine, or of the space vehicle propulsion system itself, these criteria serving to quantify margins for the subsystems relative to their modes of failure.

3. The characterization method according to claim 2, wherein the margins of the subsystems relative to their modes of failure during the lifetime of the product during a development stage followed by a production stage are caused to vary either upwards in the event of a decrease in misconceptions, or downwards in the event of drifts in production.

4. The characterization method according to claim 1, wherein the operating points of the rocket engine or of the space vehicle propulsion system are obtained by simulation using a model of the rocket engine or of the space vehicle propulsion system including uncertainties and using a statistical draw simulating the influences of various forces of dispersion, which may possibly be correlated, in order to define possible individuals of the population of rocket engines or of space vehicle propulsion systems.

5. The characterization method according to claim 1, wherein a domain is constructed by projecting points onto two dimensions in multidimensional space, the two dimensions both being representative of parameters or of conditions observed at the terminals of a given represented subsystem.

6. The characterization method according to claim 1, wherein the domains are adapted by iterative algebraic adaptation of the subsystems in order to define modified domains characterizing operation of the subsystems approaching an overall reliability target defined for the rocket engine or for the space vehicle propulsion system.

7. The characterization method according to claim 6, wherein, in a generalized algebraic method, the construction of a domain in said multidimensional space comprises a step of normalizing the population as an equivalent Gaussian population, a step of constructing a domain on the basis of the normalized population, and an inverse transformation of the domain as constructed in this way in order to obtain the looked-for domain in said three-dimensional space.

8. The characterization method according to claim 1, wherein the domains are adapted by scaling to the limits of each of the subsystem domains in order to define modified domains characterizing operation of the subsystems satisfying a reliability target defined for the rocket engine or for the space vehicle propulsion system.

9. The characterization method according to claim 1, wherein a domain is constructed while taking the coordinates of the operating points and of the reference points on at least two axes representing the respective subsystem into account by using an arbitrary envelope obtained by overall counting.

10. The characterization method according to claim 9, wherein the construction of a domain by overall counting is performed while taking account of the coordinates of the operating points and of the reference points on at least two axes representing the respective subsystem, while using angular sectors on the plane defined by the two axes.

11. The characterization method according to claim 1, wherein the proportion is determined in operation so as to define a limit operating domain, or in qualification so as to define a qualifying operating domain.

12. The characterization method according to claim 1, wherein a reliability specification for each subsystem is determined on the basis of said population as a function of the number of degrees of freedom of the rocket engine or of the space vehicle propulsion system and as a function of the rate imposed for the rocket engine or for the space vehicle propulsion system.

13. A design method for designing a rocket engine or a space vehicle propulsion system, and its component subsystems, the method comprising:
a) a determination stage for determining probabilistic operability requirements for said engine or for said system for nominal operating conditions in flight, this determination stage comprising:
an obtaining step for obtaining a population of operating points of the rocket engine or of the space vehicle propulsion system including at least two subsystems selected from an oxygen turbopump, a hydrogen turbopump, a gas generator, valves, and a propulsion chamber of the rocket engine;
followed by a construction step for constructing a plurality of predefined limit domains of said space, each representing a different subsystem, each limit domain being constructed as encompassing, around a reference point, a proportion of said population defined in the plane of the subsystem under consideration, corresponding to a projection of the operating points obtained at system level onto the plane of the subsystem under consideration, these limit domains representing observable operating conditions of the rocket engine or of the space vehicle propulsion system when in operation, resulting from various sources of dispersion;
b) a determination stage for determining probabilistic operability requirements for said engine or said system in order to qualify them, followed, for each subsystem, by a definition step for defining qualifying domains by counting points of the population lying outside a given limit, wherein said qualifying domains introduce relative to the limit domains:
qualifying directions in which the main modes of failure are critical; and
functional limitations for the subsystems constituted by criteria that must not be exceeded during a stage of development or of production;
under pain of harming the functional or mechanical integrity of the subsystem in question, or of the rocket engine, or of the space vehicle propulsion system itself, these criteria serving to quantify margins for the subsystems relative to their modes of failure;
c) an adaptation stage for adapting the domains of said subsystems as a function of the result of the counting for each subsystem and as a function of an overall reliability target defined for the rocket engine or for the space vehicle propulsion system, e.g. the proportion of said defined population for the rocket engine or for the space vehicle propulsion system;
the associated criteria defined for said subsystem that need to be complied with during a stage of development or a stage of producing said subsystems.

14. The design method according to claim 13, wherein, during said obtaining step, said population of operating points of the rocket engine or of the space vehicle propulsion system including at least two subsystems selected from an oxygen turbopump, a hydrogen turbopump, a gas generator, valves, and a population chamber of the rocket engine are obtained with operating conditions that are dispersed in a multidimensional space having axes that are each representative either of a parameter of a subsystem of the rocket engine or of the space vehicle propulsion system as represented by characterization purposes, or else of an interface of a subsystem.

15. The design method according to claim 13, wherein, during said obtaining step, said population of operating points of the rocket engine or of the space vehicle propulsion system including at least two subsystems selected from an oxygen turbopump, a hydrogen turbopump, a gas generator, valves, and a population chamber of the rocket engine is obtained, said population being constructed by effective anchoring, as made possible by this new method, of the predictive data associated with said systems and subsystems, on:
the real capability of producing various pieces of equipment and the way that capability varies, e.g. drifts in production, or improvements in fabrication processes resulting from taking appropriate account of fabrication dispersions, e.g. arbitrary statistical distributions anchored on series of equipment that have actually been fabricated;
the real capability of implementing and measuring/observing the operation of equipment on a test bench and the variations in that capability, e.g. in terms of feeding the engine, regulating testing by taking appropriate account of uncertainties in the conditions under which tests are performed; and
the predictive capability of the models used and the way that capability varies, e.g. as a reduction of misconceptions, acquiring experience during testing, enrichment of methods.

16. The design method according to claim 13, wherein the margins of the subsystems relative to their modes of failure during the lifetime of the product during a development stage followed by a production stage are caused to vary either upwards in the event of a decrease in misconceptions, or downwards in the event of drifts in production.

17. The design method according to claim 13, wherein the operating points of the rocket engine or of the space vehicle propulsion system are obtained by simulation using a model of the rocket engine or of the space vehicle propulsion system including uncertainties and using a statistical draw simulating the influences of various sources of dispersion, which may possibly be correlated, in order to define possible individuals of the population of rocket engines or of space vehicle propulsion systems.

18. The design method according to claim 13, wherein a domain is constructed by projecting points onto two dimensions in multidimensional space, the two dimensions both being representative of parameters or of conditions observed at the terminals of a given represented subsystem.

19. The design method according to claim 13, wherein the domains are adapted by iterative algebraic adaptation of the subsystems in order to define modified domains characterizing operation of the subsystems approaching an overall reliability target defined for the rocket engine or for the space vehicle propulsion system.

20. The design method according to claim 19, wherein, in a generalized algebraic method, the construction of a domain in said multidimensional space comprises a step of normalizing the population as an equivalent Gaussian population, a step of constructing a domain on the basis of the normalized population, and an inverse transformation of the domain as constructed in this way in order to obtain the looked-for domain in said three-dimensional space.

21. The design method according to claim 13, wherein the domains are adapted by scaling to the limits of each of the subsystem domains in order to define modified domains characterizing operation of the subsystems satisfying a reliability target defined for the rocket engine or for the space vehicle propulsion system.

22. The design method according to claim 13, wherein a domain is constructed while taking the coordinates of the operating points and of the reference points on at least two axes representing the respective subsystem into account, by using an arbitrary envelope obtained by overall counting.

23. The design method according to claim 22, wherein the construction of a domain by overall counting is performed while taking account of the coordinates of the operating points and of the reference points on at least two axes representing the respective subsystem, while using angular sectors on the plane defined by the two axes.

24. The design method according to claim 13, wherein the proportion is determined in operation so as to define a limit operating domain, or in qualification so as to define a qualifying operating domain.

25. The design method according to claim 13, wherein a reliability specification for each subsystem is determined on the basis of said population as a function of the number of degrees of freedom of the rocket engine or of the space vehicle propulsion system and as a function of the rate imposed for the rocket engine or for the space vehicle propulsion system.
